(19) United States
(12) Patent Application Publication
(10) Pub. No.: US 2004/0252366 A1
(43) Pub. Date: Dec. 16, 2004

(54) Optical amplifier having fast Raman tilt control

(76) Inventor: Rene Monnard, Cupertino, CA (US)

Correspondence Address: Jeffery J. Brosemer, Ph.D., ESQ., 138 S. Telegraph Hill Road, Holmdel, NJ, 07733, US

(21) Appl. No.: 10/460,997

(22) Filed: Jun. 13, 2003

(51) Int. Cl. H01S 3/00

(52) U.S. Cl. 359/337

(57) ABSTRACT

A method and apparatus for controlling gain tilt in an optical amplifier that adjusts the tilt based on the optical signals entering the optical amplifier and in particular, on a “feed-forward”, predictive methodology that monitors optical signals entering an optical amplifier as opposed to prior art, spectral monitoring techniques that monitor optical signals emanating from an optical amplifier and adjust tilt accordingly.

### FIELD OF THE INVENTION

This invention relates generally to the field of optical communications and in particular to an optical amplifier having fast Raman tilt control.

### BACKGROUND OF THE INVENTION

Optical communication systems typically use wavelength-division multiplexing to increase transmission capacity. More specifically, a plurality of optical signals each having a different wavelength are multiplexed together into a wavelength division multiplexed (WDM) signal. The WDM signal is transmitted over a transmission line, and then subsequently demultiplexed so that individual optical signals may be individually received.

An optical amplifier is typically used in such optical communication system to amplify the WDM signal. Since such optical amplifiers have a relatively broad band, the optical amplifier permits each individual optical signal in the WDM signal to be amplified at the same time.

Generally, an optical amplifier includes an optical amplifying medium, such as an erbium-doped fiber (EDF). The WDM signals travel through the optical amplifying medium. The optical amplifier also includes a light source, such as a laser diode, which provides an optical “pump” to the optical signals traveling through the optical amplifying medium. In a common application, repeating devices, each having an optical amplifier, are interposed into the transmission line to facilitate the transmission of optical signals over great distances.

Moreover, the gain of an optical amplifier is dependent on the wavelength of the amplified signal. This dependence is defined as the “gain tilt” of the optical amplifier. Therefore, when a WDM signal is amplified by an optical amplifier, each of the individual optical signals multiplexed together may be amplified with a different gain. Accordingly, the gain tilt of an optical amplifier must be considered when using an optical amplifier to amplify WDM signals and a continuing need exists in the art for methods and apparatus which adjust for gain tilt in optical amplifiers.

### SUMMARY OF THE INVENTION

I have developed a method and apparatus for controlling gain tilt in an optical amplifier. Unlike prior art methods which provide adjustment based on signals leaving the optical amplifier, my inventive method and apparatus adjusts the tilt based on the optical signals entering the optical amplifier.

Viewed from a first aspect, my invention is directed to a method of tilt control which is based on a “feed-forward”, predictive methodology that monitors the total optical signal power entering an optical amplifier as opposed to prior art, spectral monitoring techniques that monitor optical signals emanating from an optical amplifier and adjust tilt accordingly.

Viewed from another aspect, my invention is directed to an optical amplifier apparatus that adjusts the gain tilt based upon the optical signals entering the optical amplifier.

Additional objects and advantages of my invention will be set forth in part in the description which follows, and, in part, will be obvious from the description, or may be learned by practice of the invention.

### BRIEF DESCRIPTION OF THE DRAWING

FIG. 1 is a schematic representation of an optical amplifier constructed according to the teachings of the present invention;

FIG. 2 is a schematic representation of an alternative embodiment of an optical amplifier constructed according to the teachings of the present invention;

FIG. 3 is a further schematic representation of an optical amplifier according to the teachings of the present invention and;

FIG. 4 is a schematic representation of variations to the optical amplifier according to the teachings of the present invention.

### DETAILED DESCRIPTION OF THE PREFERRED EMBODIMENTS

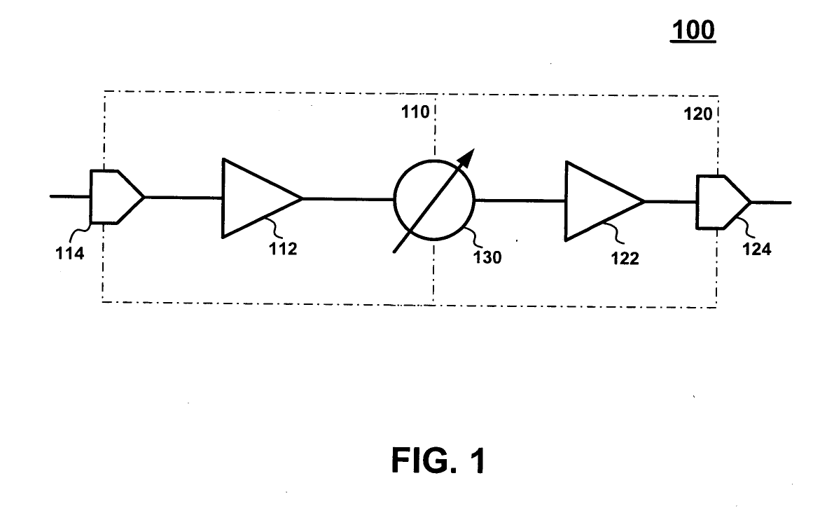

With reference now to FIG. 1, there is shown in schematic form a two stage optical amplifier 100, which exhibits my inventive teachings. More specifically, optical amplifier 100 includes two stages, stage-1 (shown in the FIG. 1 as 110, and stage-2 (shown in the FIG. 1 as 120).

Each of the two individual stages 110 and 120 includes a pump and a monitor diode. In particular, stage-1 110 includes pump 112 for pumping stage-1 and monitor diode-1 114 for monitoring the input of stage-1, while stage-2 120 includes pump 122 for pumping stage-2 and monitor diode-2 124 for monitoring the output of stage-2. Shown further in FIG. 1, the two stages 110 and 120 are optically connected by variable optical attenuator (VOA) 130, interposed between stage-1 110 and stage-2 120.

As can be appreciated by those skilled in the art, the overall gain of optical amplifier 100 is the ratio between the output and the input power or the difference in optical power as measured by monitor diode-1 114 and monitor diode-2 124 where the gain is expressed in dB and the power measured in dBm. Stated precisely,

GAIN=MPD2−MPD1

Further, the gain of the amplifier is produced by doped-fiber, for example, erbium doped fiber. The net gain of such an optical amplifier is the difference between the gain produced by the erbium doped fiber and loss introduced from components such as isolators, couplers, VOA's or gain flattening filters.

In my inventive method and apparatus, the tilt of the optical amplifier 100 is adjusted by adjusting the VOA 130. In this inventive manner, virtually any adjustment to tilt is possible.

Further, it is possible with my inventive apparatus and method to provide an optical amplifier with tilt control over a broad range of response times. While sub-millisecond adjustments are oftentimes desirable to prevent loss of signal in a WDM transmission system, longer times may be suitable for different applications.

Still further, several different implementations of my inventive optical amplifier are possible. More specifically, and depending upon amplifier construction including erbium doped fiber type(s) used, the number of VOA's and their positioning depends upon the specific application environment.

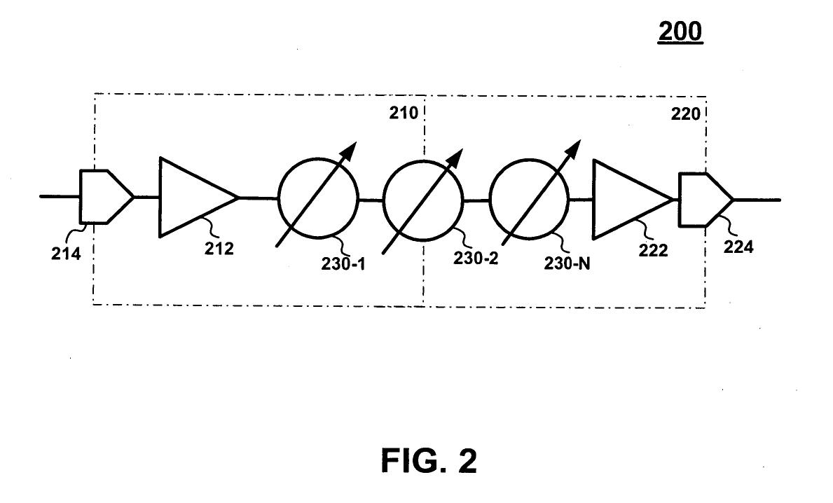

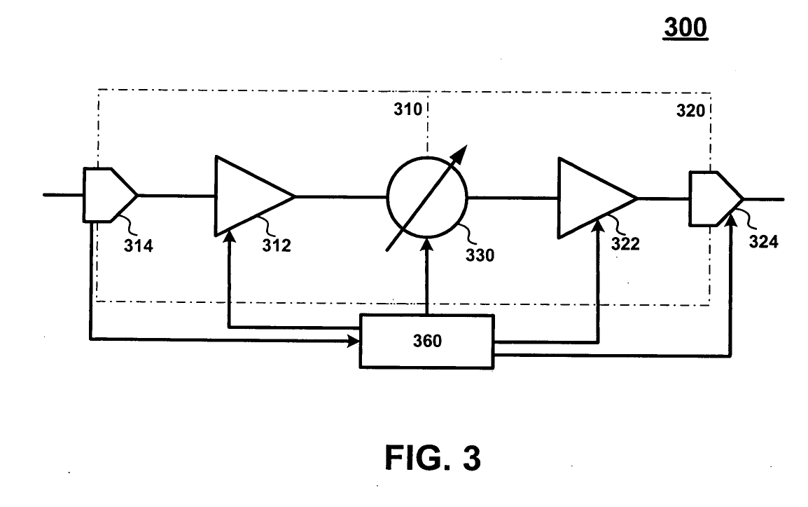

With reference now to FIG. 2, there is shown an alternative optical amplifier 200, having multiple VOA's (230-1, 230-2)

With continued reference now to FIG. 2, a two stage optical amplifier 200 includes two stages, stage-1 (shown in the FIG. 2 as 210, and stage-2 (shown in the FIG. 2 as 220).

Each of the two individual stages 210 and 220 includes a pump and a monitor diode. In particular, stage-1 210 includes pump 212 for pumping stage-1 and monitor diode-1 214 for monitoring the input of stage-1, while stage-2 220 includes pump 222 for pumping stage-2 and monitor diode-2 224 for monitoring the output of stage-2. Shown further in FIG. 2, the two stages 210 and 220 are optically connected by multiple variable optical attenuators (VOA) 230-1, 230-2 . . . 230-N, interposed between stage-1 210 and stage-2 220.

As was shown prior, for mid-stage access amplifiers, a single VOA may be used to adjust for the gain, the mid stage loss padding and the tilt control. If such an amplifier needs to provide a large gain range, then multiple VOA's, such as that shown in FIG. 2 may advantageously be used.

Turning our attention now to FIG. 3, there is shown schematic form a two stage optical amplifier 300, which exhibits my inventive teachings. More specifically, optical amplifier 300 includes two stages, stage-1 (shown in the FIG. 3 as 310, and stage-2 (shown in the FIG. 1 as 320).

Each of the two individual stages 310 and 320 includes a pump and a monitor diode. In particular, stage-1 310 includes pump-1 312 for pumping stage-1 and monitor diode-1 314 for monitoring the input of stage-1, while stage-2 320 includes pump-2 322 for pumping stage-2 and monitor diode-2 324 for monitoring the output of stage-2. As was shown in a similar manner during our discussion of the optical amplifier 100 of FIG. 1, the two stages 310 and 320 of optical amplifier 300 depicted in this FIG. 3 are optically connected by variable optical attenuator (VOA) 330, interposed between stage-1 310 and stage-2 320.

Shown further in FIG. 3, output monitor (OMON) 350 and amplifier control unit 360. Output monitor (OMON) 350 monitors the overall output of the amplifier 300 and provides feedback input to amplifier control unit 360, which in turn, controls the pumps 312, 322, and VOA 330.

At this point, one can appreciate the distinctions between our inventive feed-forward, fast tilt control optical amplifier and a slow tilt control optical amplifier.

In particular, in a slow tilt control optical amplifier, the spectral response would be measured at the overall output of the amplifier 300, and the VOA 330 would be adjusted by the action of amplifier control unit 360 to achieve a target gain tilt.

In sharp contrast, and according to my inventive teachings of fast tilt control, the VOA is adjusted dynamically based on input power. Stated more precisely:

ΔVOA f(input power, gain).

In particular, where “Att” is the attenuation or loss,

VOA value=Att(input power, FA gain)+Att(OMON)+Att(FA gain);

Where

i. Att(FA gain) is the attenuation needed to achieve substantially flat gain—which may be an attenuation value determined during manufacturing calibration of the fiber amplifier, and in particular an erbium doped fiber amplifier;

ii. Att(OMON) is an attenuation correction based on a target tilt and OMON value; and

iii. Att(input power, FA gain) is an attenuation value based on monitor diode-1 314 and fiber amplifier gain setting. This function is dependant of the transmission fiber used, signal band used (C-band, L-band, extended L-band, etc.) as well as other parameters from the system (channel spacing, channel loading scheme.)

In this inventive manner, virtually any adjustment to tilt is possible. More particularly, the attenuation of the input power and fiber amplifier gain advantageously may be continuously adjusted or adjusted when input power change reaches a threshold.

Additionally, it should be apparent to those skilled in the art that any of a variety of devices may be used in place of the VOA's shown herein. In particular, VOA's used as tilt devices may advantageously be replaced by any device having an adjustable wavelength loss function.

In particular, devices that exhibit loss functions for a given voltage V1, wherein a short wavelength is more attenuated than a long wavelength, would exhibit a different loss at a different voltage, V2.

Additionally, other devices which would prove suitable replacements for the VOA's shown and described herein include: Micro-Electro-Mechanical Systems (MEMS) devices, electromagnetic VOA's, and liquid crystal devices—as well as other devices exhibiting a controllable loss.

Clearly, such devices could exhibit rapid response times, in the micro-second range. Longer responding times, such as millisecond response times, may be satisfactory for particular applications.

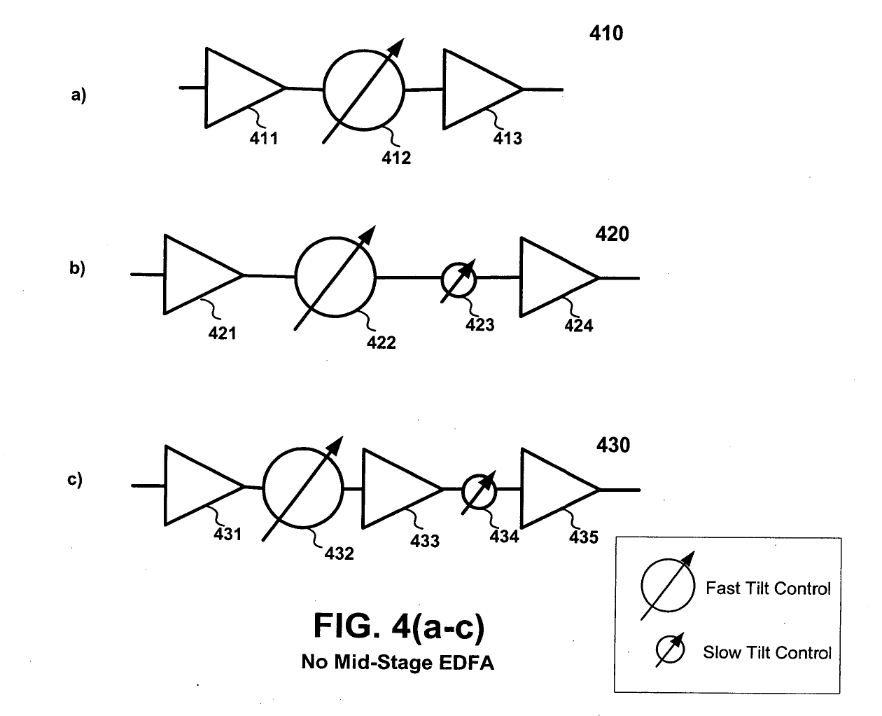

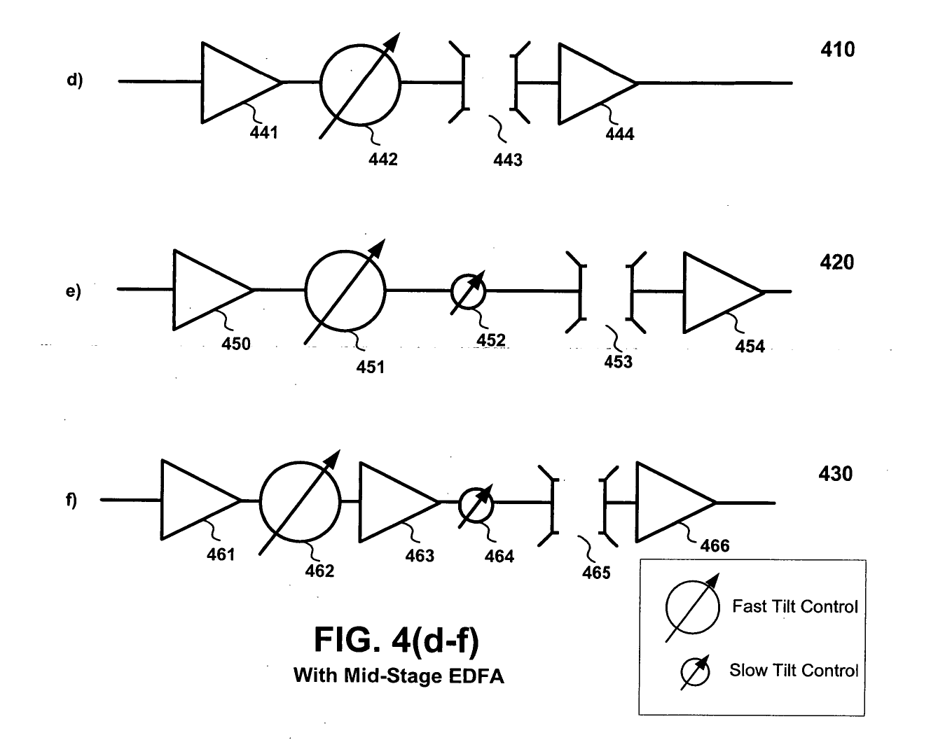

Finally, and with reference now to FIG. 4, there is shown in schematic form various different configurations of optical amplifiers constructed according to my present teachings, both without a mid-stage erbium-doped fiber amplifier (EDFA) (FIG. 4a-c) and with a mid-stage EDFA.

More specifically, in FIG. 4a, there is shown a configuration including pumps 411, 413 in communication with VOA 412 which is interposed between the two pumps, such as the configurations shown previously. An alternative of this arrangement is shown in FIG. 4d, in which a mid-stage EDFA 433 is interposed between the two pumps 441, 444 as well. FIG. 4b-f show additional arrangements and even hybrid arrangements including both “fast” tilt control and normal, slow tilt control as depicted in FIG. 4e having fast tilt VOA 4512 and slow tilt VOA 452.

Of course, it will be understood by those skilled in the art that the foregoing is merely illustrative of the principles of this invention, and that various modifications can be made by those skilled in the art without departing from the scope and spirit of the invention.

What is claimed is:

1. A method of gain tilt control for an optical amplifier comprising the steps of:
monitoring an optical signal entering the optical amplifier; and
adjusting the tilt of the optical amplifier as a function of the monitored optical signal.

2. The method according to claim 1 further comprising the step of:
determining an attenuation value for a variable optical attenuator (VOA).

3. The method according to claim 2 wherein a change in said attenuation value is determined according to the following relationship:
ΔVOA=f(input power, gain);
where
input power is an input power of the optical signal and gain is the gain of the optical amplifier.

4. The method according to claim 2 wherein the attenuation value is determined according to the following relationship:
VOA=Att(input power, FA gain)+Att(OMON)+Att(FA gain);
where
Att(input power, FA gain) is an attenuation value determined from a monitor positioned at an input of the optical amplifier and FA gain;
Att(OMON) is an attenuation value based on a target tilt and on a monitor positioned at an output of the optical amplifier; and
Att(FA gain) is an attenuation needed to achieve a substantially flat gain.

5. A an optical amplifier comprising:
means for monitoring an optical signal entering the optical amplifier; and
means for adjusting the tilt of the optical amplifier as a function of the monitored optical signal.
